(19) United States
(12) Patent Application Publication
(10) Pub. No.: US 2009/0287667 A1
(43) Pub. Date: Nov. 19, 2009

(54) Data processing method and apparatus thereof

(76) Inventor: Shivkumar KANNAN, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/145,503

(22) Filed: Jun. 25, 2008

(30) Foreign Application Priority Data
May 13, 2008 (IN) 1167/CHE/2008

(51) Int. Cl. G06F 7/06; G06F 17/30

(52) U.S. Cl. 707/4; 707/E17.014; 707/E17.055

(57) ABSTRACT

The invention relates to a data processing method comprising: receiving an attribute request from a device management client by a server using a first access protocol, wherein the attribute request comprises a first representation of an attribute of an element of a data processing system; mapping the attribute request from the first representation into a second representation, the second representation being an object-oriented standard representation comprising: objects, types of objects, collection of objects and attributes of objects, wherein the objects represent a set of elements; fetching the attribute from a cache coupled to the server, if the cache stores the attribute of the element; transforming the attribute request from the first protocol into a second protocol, if the attribute is not stored in the cache; fetching from a device management provider coupled to the element a plurality of attributes including the attribute using the second protocol, if the attribute is not stored in the cache; storing the plurality of attributes including the attribute in the cache with the object-oriented standard representation and sending the attribute to the device management client.

### RELATED APPLICATIONS

Benefit is claimed under 35 U.S.C. 119(a)-(d) to Foreign application Serial No. 1167/CHE/2008 entitled “DATA PROCESSING METHOD AND APPARATUS THEREOF” by Hewlett-Packard Development Company, L.P., filed on 13 May, 2008, which is herein incorporated in its entirety by reference for all purposes.

### BACKGROUND

The standardization bodies have outlined standards and protocols for managing various elements in a data processing system. The elements may include servers, storage mediums, networks and software applications. As the networks increase in size, the amount of data to be handled by device management providers increases. The device management providers use a variety of protocols to retrieve data from the elements. These protocols add a delay to the time needed for a response. If the element is heavily loaded and performing computing or input/output operations, the processor in the element takes more time to respond to the management queries from the device management providers.

### BRIEF DESCRIPTION OF THE DRAWINGS

In the following preferred embodiments of the invention will be described in greater detail by way of example only making reference to the drawings in which:

FIG. 1 shows a block diagram of an embodiment of a data processing system,

FIG. 2 shows a flowchart of an embodiment of a data processing method,

FIG. 3 shows a flowchart of another embodiment of a data processing method.

FIG. 4 shows an example of the object-oriented representation of data stored in the cache.

### DETAILED DESCRIPTION OF THE INVENTION

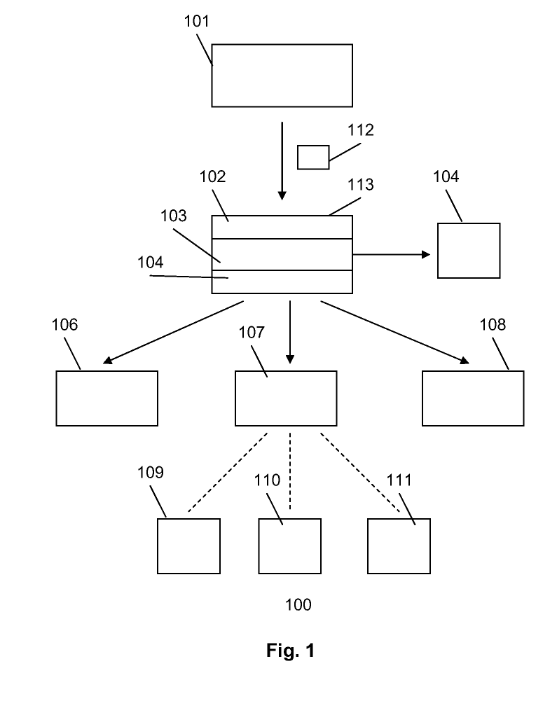

FIG. 1 shows a block diagram 100 of a data processing system comprising a device management client 101. The device management client 101 comprises a management application for the management of elements of the data processing system. The elements may include networks, storage devices, computer systems or software applications. The management application may also manage resources, and monitor the status and performance of elements at periodic intervals. A server 113 is coupled to the device management client 101 and comprises a first adapter 102, a core service 103 and a second adaptor 105. The server 113 is coupled to a cache 104 and to first, second and third device management providers 106, 107,108. The second device management provider is coupled to first, second and third elements 109, 110 and 111 and is used to retrieve information from the elements.

When the management application of the client 101 requires information about an element of the data processing system, the client sends an attribute request 112 to the server 113. This attribute request may follow a specification, as for example the Web-Based Enterprise Management (WBEM) specification. The information requested may be, for example, the attributes of a computer system, the used capacity of a disk, or the discovery of new connected elements to a computer system. The attribute request is transmitted using a first protocol with a first representation of the requested information.

The first protocol may be for example: the Common Information Model—XML (CIM-XML), the Web Services for Management (WS-Management), or the Web Services Distributed Management (WS-DM). The first representation of the attribute request may use, for example, XML. The first representation may include the operation name, and the parameters that specify the request, including the elements of the data processing system and the requested attributes.

The first adapter 102 within the server 113 maps the received attribute request from that first representation into a second representation. The second representation is an object oriented standard representation, as for example the Common Information Model (CIM). The object oriented representation includes objects, type of objects, a collection of objects and attributes of objects. The information stored in the cache may be represented using the Common Information Model (CIM) classes, namespaces, class names and instances. The server may be a Common Information Model object manager (CIMOM) server.

Each object stored in the cache represents an element of the data processing system. In the object oriented standard representation, the objects maybe associated with each other and the association is stored in a new object. All objects within a specific type of object share specific characteristics. During the mapping, the object, the type of object, the collection of objects and the cache parameter are identified. The cache parameter enables or disables the use of the cache during the attribute request. If the attribute request does not include the cache parameter, the cache may be by default ‘enabled’ or ‘disabled’.

If the requested attribute is stored on the cache 104, the server 113 fetches the attribute from the cache 104. The cache 104 stores information that describes a plurality of attributes of the set of elements or devices 109, 110 and 111. This information is stored using the object oriented standard representation. The cache facilitates a reduction of the delays of the attributes request and the load of the providers, as the request does not require to fetch the elements or the device management providers for every single operation. Therefore, the cache allows handling more elements by a single device management provider. The cache is compatible with different versions and types of device management providers, as the information is stored with the object oriented standard representation, and not in the representation of a single provider type. The cache also supports different access protocols from the device management client.

If the information is not stored in the cache, the server fetches the attributes from the first device management provider 106, that is connected to the element with the requested attribute. In order to perform the fetching operation, a second adaptor 105 transforms the attribute request from a first protocol to a second protocol. The second protocol may be a standardized interface. Examples of second protocols are the Common Manageability Programming Interface (CMPI) or proprietary interfaces. The first device management provider 106 responds to the attribute request and send the required information back to the server 113. The cache 104 stores this information sent by the device management provider and the response is sent back to the device management client 101. The information is stored using the object oriented standard representation.

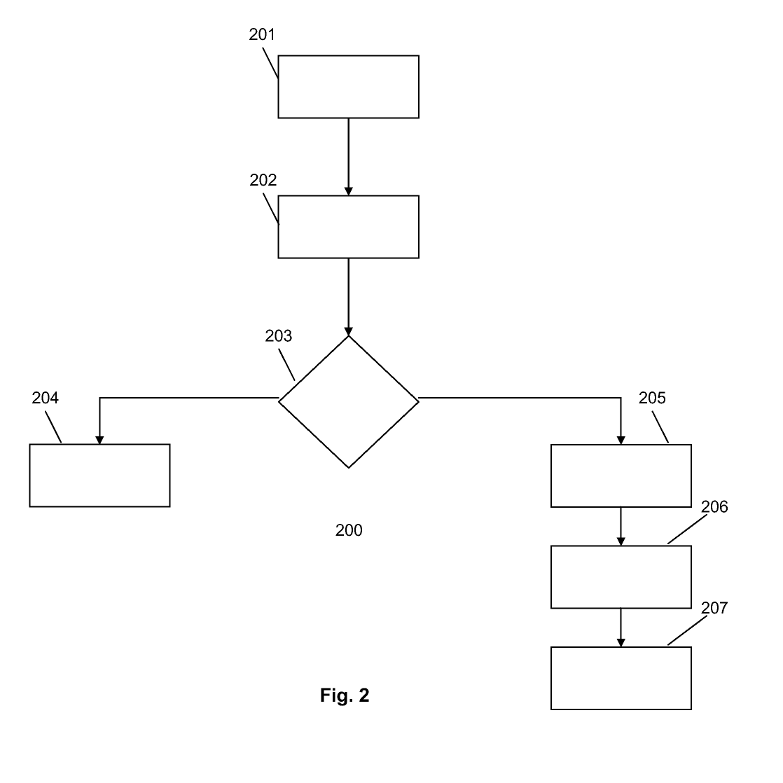

FIG. 2 shows a flowchart of a data processing method 200. In a first step 201 the server receives an attribute request from a device management client. The attribute request is sent using a first access protocol with first representation and the attribute request specifies the required attribute of a set of elements of a data processing system. In a second step 202 the attribute request is mapped from a first representation to an object oriented standard representation. The mapping includes identifying an object, a type of object, a collection of objects and a requested attribute of an object, each object representing an element of a data processing system.

In a third step 203, the cache is checked if it contains the requested attributes of the element. In a fourth step 204, the server fetches the attributes from the cache. This information is stored in the cache using the object oriented standard representation. In the case that the information is not available in the cache, the attribute request is transformed from a first protocol into a second protocol in step 205. In step 206, the attribute is fetched from one of the set of device management providers using the second protocol. Finally, in a seventh step 207, the cache stores the fetched attribute and the response is further sent to the client.

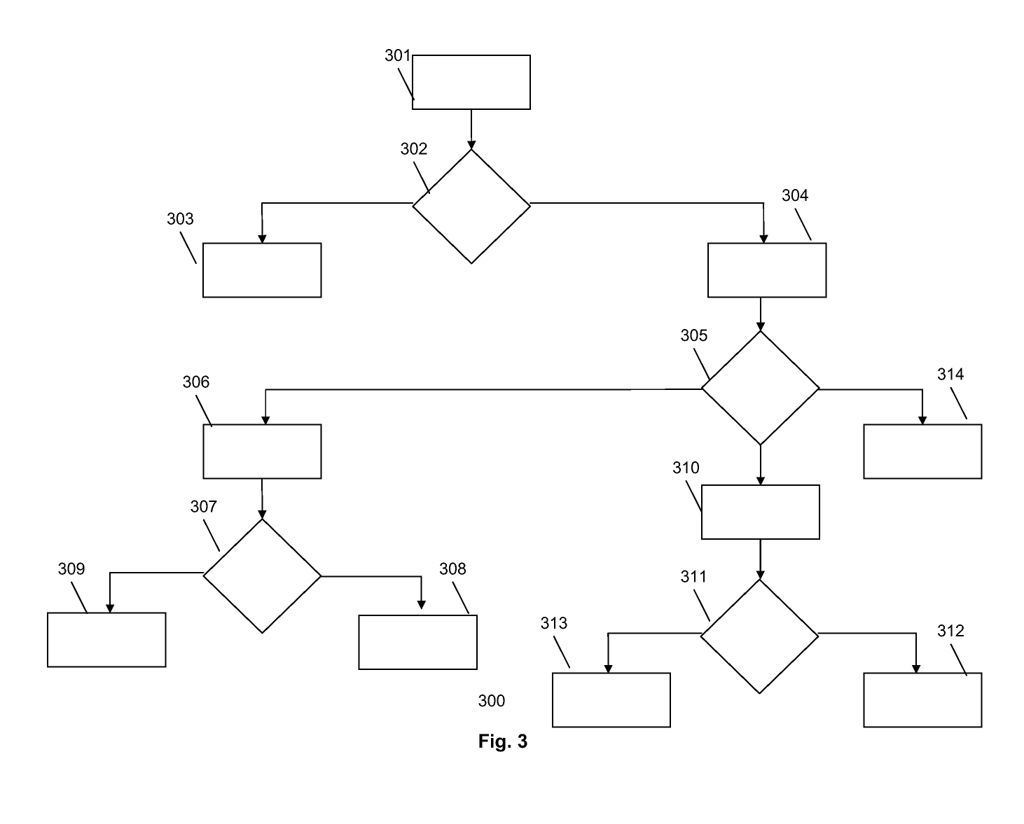

FIG. 3 shows a second flow diagram 300 of a further data processing method 300. In first step 301, a server identifies the cache parameter from the attribute request. The cache parameter indicates the instructions of the client regarding the use of the cache. In a second step 302, the server reads the content of the cache parameter and if the cache parameter is activated, a third step 303 fetches the attribute from the cache. If the cache does not contain the attribute requested, the steps 205 and 206 of the FIG. 2 are completed. If the cache parameter is deactivated, or if the cache parameter is not available in the attribute request, in a fourth step 304, the server identifies a first device management provider of the set of providers coupled to the element containing the required attribute. Then, the server fetches the disabled cache instructions from the first provider. The disabled cache instructions describe the specifications from the provider regarding the use of the cache, when the cache parameter is ‘disabled’. The disabled cache instructions may include: “periodically refresh”, “check immediate” and “synchronized update”.

In a fifth step 305, the server reads the content of the disabled cache instruction. If the content of the disabled cache instruction reads “periodically refresh”, in a sixth step 306, the server obtains the provider specific timeout interval. In a seventh step 307, the server compares the timeout interval with the time when the information was retrieved and stored in the cache. If the data or information in the cache is within the time interval, in an eighth step 308 the server fetches from the cache the information that is required by the attribute request. If the data cache is not within the time interval, in a ninth step 309 the server fetches the required information from the first device management provider, updates the information in the cache and sends the response back to the client.

If the disabled cache instruction is “check immediate” in a tenth step 310, the server verifies with the first device management provider whether there are any changes to the information in an eleventh step 311. If there are changes, in the step 312 the server refreshes the cache with the updated information and sends the updated information back to the client. If there are no changes to the information or attributes, the data from the cache is returned to the client in step 313. Finally, if the disabled cache instruction is a “synchronized update”, the step 314 returns the data from the cache using the algorithm specified in the attribute request. In the synchronized update, the device management provider keeps the cache up to date using an asynchronous mechanism, that may include for example the use of events.

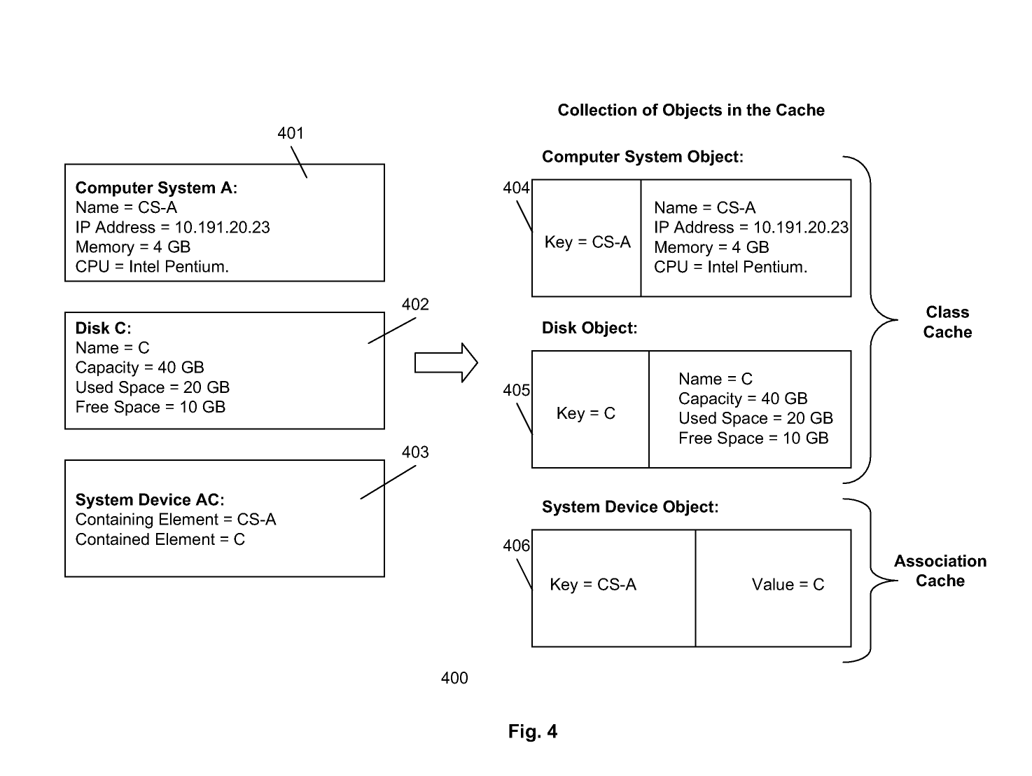

FIG. 4 shows an example 400 of three different types of elements 401, 402 and 403 and their attributes of a data processing system, which are stored in the cache with an object-oriented representation. The first element 401 is a computer system A. The second element 402 is a disk c and the third element 403 is a system device AC.

The attributes of the computer system 401 include: Name: CS-A, IP Address: 10.191.20.23, Memory: 4 GB, CPU=Intel Pentium. The attributes of the disk C 402 include: C, Capacity: 40 GB, Used Space: 30 GB, Free Space: 10 GB. The attributes of the system device ac are: the computer system A as the containing element and the disk c as the contained element. This is understood as the disk C as a part of the computer system A.

The element and their attributes are represented in the cache as objects using the object-oriented standard representation. The representation includes objects, collection of objects and type of objects. The first element 401 is part of the computer system objects. The second element 402 is part of the disk objects. The third element 403 is part of the system device objects. The system device object is an association object. The association objects relates the elements between each other.

The cache stores a first collection of objects containing: the computer system, disk and system device objects. Each object includes a key value and a group of attributes, also called instances. The computer system object 404 stored in the cache contains the key=CS-A and the instances: Name=CS-A, IP=10.191.20.23, memory=4 GB and CPU=Intel Pentium.

The disk object 405 contains the key=C and the instances: Name=C, capacity=49 GB, used space=30 GB and free space=10 GB. Finally, the system device object 406 is stored with the key=CS-A, that also represents the containing element key value. The instance value=C, that represents the contained element. If, for example, the server requires to retrieve the information stored in the cache, the operation ‘enumerateInstances (computer system object)’ returns the object 404 with their attributes. If only an enumeration of the objects is required, the operation ‘enumerateInstanceNames (computer system object)’ returns only the vey value=CS-A without the attributes.

As the stored information in the cache is independent of the procotols and interfaces used by the device management providers and the device management clients, the cache can be used across different versions and typed of clients and providers, and can reduce the delay of the attribute request, and the load of the device management provider. If the information is not available in the cache, the server may fetches all available information from the device management provider. The fetching of all available information may be performed with the ‘enumerateInstances’ operation. Before the response is sent to the client, the information is stored in the cache, avoiding further requests directly to the provider.

The steps of the method or algorithm described herein may be embodied directly in a hardware, in a software module executed by a processor or in combination of the two. A software module may reside in RAM memory, flash memory, hard disk, a removable disk, or any other form of storage medium. The storage medium may be coupled to the process or may be integral to the processor.

### LIST OF REFERENCES

100 Block diagram

101 Device management client

102 First adapter

103 Core service

104 Cache

105 Second adapter

106 First provider

107 Second provider

108 Third provider

109 First element

110 Second element

111 Third element

112 Attribute request

113 Server

200 Flow chart

201 First step

202 Second step

203 Third step

204 Forth step

205 Fifth step

206 Sixth step

300 Flow chart

301 First step

302 Second step

303 Third step

304 Forth step

305 Fifth step

306 Sixth step

307 Seventh step

308 Eight step

309 Ninth step

310 Tenth step

311 Eleventh step

312 Twelfth step

313 Thirteenth step

314 Fourteenth step

400 Example of three objects

401 First object

402 Second object

403 Third object

404 Computer system object

405 Disk object

406 System device object

1. A data processing method comprising:
receiving an attribute request from a device management client by a server using a first access protocol, wherein said attribute request comprises a first representation of an attribute of an element of a data processing system;
mapping said attribute request from said first representation into a second representation, said second representation being an object-oriented standard representation comprising: objects, types of objects, collection of objects and attributes of objects, wherein said objects represent a set of elements;
fetching said attribute from a cache coupled to said server, if said cache stores said attribute of said element;
transforming said attribute request from said first protocol into a second protocol, if said attribute is not stored in said cache;
fetching from a device management provider coupled to said element a plurality of attributes including said attribute using said second protocol, if said attribute is not stored in said cache;
storing said plurality of attributes including said attribute in said cache with said object-oriented standard representation and sending said attribute to said device management client.

2. The method of claim 1, wherein said attribute request further comprises a cache parameter, wherein said fetching to said cache is completed if said cache parameter is activated, wherein said fetching to said cache is disabled, if said cache parameter is deactivated.

3. The method as in claim 1, wherein the method further comprises:
identifying a first device management provider of said set of providers, wherein said first provider is coupled to said element; and
fetching disabled cache instruction of said first provider.

4. The method as in claim 3, wherein said fetching to said cache is completed, if said disabled cache instructions of said first provider is a periodic refresh with a time interval and if said information on said cache was received from said first provider within said time interval

5. The method as in claim 3, wherein the method further comprises:
checking if said information stored in said first provider has been changed, storing said changes in said cache and completing said fetching to said cache, if said disabled cache instructions is a check immediate.

6. The method as in claim 3, wherein if said disabled cache instruction is an asynchronous update, said information on said cache is updated using an asynchronous mechanism.

7. The method as in claim 1, wherein said first access protocol is an access protocol and is one of: Common Information Model—XML, Web Services for Management, or Web Services Distributed Management.

8. The method as in claim 1, wherein said information is stored on said cache is structured into Common Information Model classes, namespaces, class names and instances.

9. The method as in claim 1, wherein said server is a Common Information Model object manager server, wherein the method further comprises: fetching all available information on said first provider and storing it in said cache, if said information of said element is not stored in said cache.

10. The method as in claim 1, wherein fetching all available information is completed with an enumerateInstances operation.

11. A device management server comprising:
a first adapter adapted for receiving attribute requests from a device management client by a server using a first access protocol with a first representation and mapping said attribute request from said first representation into an object-oriented standard representation, wherein said attribute request specifies an attribute of an element of a data processing system, wherein said object-oriented representation includes: objects, types of objects, collection of objects and attributes of objects, wherein said objects represent said set of elements,
a core service adapted for fetching said attribute from a cache coupled to said server, wherein said cache is adapted for storing information describing a plurality of attributes of said set of elements, wherein said information is stored in said cache with said object-oriented standard representation,
a second adapter for transforming said attribute request from said first protocol into a second protocol and fetching a plurality of attributes including said attribute from a device management provider coupled to said element using said second protocol, if said instance is not stored in said cache.

12. A device management server as in claim 11, wherein said cache is further adapted for storing all available information from said device management provider, if said information of said element is not stored in said cache.

13. A device management server as in claim 11, wherein said device management server is a Common Information Model object manager server.

14. A computer program product stored on a computer usable medium, comprising computer readable program means for causing a computer to perform a method according to claim 1 when said program is run on said computer.
